(19) United States
(12) Patent Application Publication
(10) Pub. No.: US 2002/0189112 A1
(43) Pub. Date: Dec. 19, 2002

(54) Cartridge loading system for a razor assembly

(76) Inventor: Mark Peyser, Easton, CT (US)

Correspondence Address: Gregg C. Benson, Pfizer Inc., Patent Department, MS 4159, Eastern Point Road, Groton, CT, 06340, US

(21) Appl. No.: 10/132,815

(22) Filed: Apr. 24, 2002

Related U.S. Application Data
(60) Provisional application No. 60/287,144, filed on Apr. 27, 2001.

(51) Int. Cl. B26B 21/52

(52) U.S. Cl. 30/527; 30/50

(57) ABSTRACT

A shaving assembly includes a razor cartridge having an underside and a pair of resilient prongs extending from the underside, each resilient prong having a barb-like projection at an outer end, the resilient prongs being deflectable in response to external forces. The razor cartridge is attachable to a razor handle including a yoke having a securing seat with opposing side walls and a central aperture extending between the opposing side walls, each side wall having a slot. When attaching the razor handle to the cartridge, the resilient prongs are insertible into the central aperture for capturing the barb-like projections in the slots of said side walls. The barb-like projections may slide in the slots so that the cartridge is pivotable relative to the handle.

### CROSS-REFERENCE TO RELATED APPLICATIONS

The present application is a U.S. non-provisional application. This application claims the benefit of U.S. No. 60/287,144, filed on Apr. 27, 2001, under 35 USC 119(e).

### BACKGROUND OF THE INVENTION

The present invention relates to razor cartridge loading systems. More particularly, the present invention relates to a razor assembly including a razor cartridge having one or more resilient elements for being secured to an upper end of a razor handle.

Wet shaving systems employing a disposable razor have been widely used for many years. The earliest systems included a razor cartridge mounted in a fixed position relative to the razor handle. Later shaving systems pivotally mounted the razor cartridge to the razor handle so that the cartridge could move when following the contour of a shaving surface.

There are many different designs for pivotally connecting a razor cartridge to a razor handle. One popular design provides a razor handle having opposing journals actuated by a push-button. Actuating the pushbutton moves the opposing journals between “open” and “closed” positions for engaging the journal bearings of a pivotable razor blade cartridge. The razor handle typically includes a spring-biased cam follower for engaging a cam surface on an underside of the razor blade cartridge. The spring-biased cam follower urges the razor cartridge into an undeflected orientation.

In U.S. Pat. No. 4,083,104, a push-button is actuated for holding opposing journals in an “open” position. However, the assembly disclosed in the '104 patent requires extreme manual dexterity and a complex process for manufacturing a razor handle.

Commonly assigned U.S. Pat. No. 4,266,340, the disclosure of which is hereby incorporated by reference herein, discloses a razor handle adapted to have razor blade cartridges pivotally mounted thereon. The razor handle includes a cam follower, a spring and a pusher assembled together to form an interlocking subassembly to facilitate handling and installation of the cartridge into the razor handle housing. The cam follower and pusher each include a stop surface, the stop surfaces being oriented so that one moves into limiting engagement with the other under the biasing action of the spring.

Commonly assigned U.S. Pat. No. 6,138,361, the disclosure of which is hereby incorporated by reference herein, discloses a razor assembly, whereby the razor cartridge is pivotally mountable on an associated handle assembly. The razor cartridge includes first and second end members and at least one blade extending between the first and second end members. Each end member includes a curved journal that enables pivotal connection of the razor cartridge to the razor handle. The curved journals extend inwardly from the respective inner surfaces of the first and second end members.

U.S. Pat. No. 5,347,717 to Ts'ai discloses a disposable razor including a chucking device having two pawls controlled by a press rod, the pawls being movable toward each other for loading a blade cartridge. The pawls are interconnected with a spring that urges the pawls away from one another the razor cartridge has been engaged by the pawls. The chucking device also includes a spring-supported balance rod for balancing the loaded razor cartridge. Pushing on the press rod causes the pawls to move toward one another so that the pawls can be inserted into a space between hooks extending below the razor cartridge. When the press rod is released, the spring causes the pawls to extend outwardly away from one another for engaging the opposing hooks and securing the razor cartridge to the handle.

U.S. Pat. No. 4,428,116 to Chen discloses a support for releasably retaining a blade cartridge. The support preferably terminates in a flexible yoke having a slide element cooperating therewith. The slide element is movable between a first position in which the yoke is closed to a second position in which the yoke is flexed outwardly for receiving the blade cartridge. After the blade cartridge has been secured within the yoke, a spring interconnected with the slide returns the slide element to the first position, thereby enabling the yoke to flex inwardly for retaining releasably a cartridge.

U.S. Pat. No. 5,956,851 to Apprille, Jr. et al. discloses a shaving system including a handle and replaceable cartridges that may be attached to the handle. Each replaceable cartridge includes a blade unit and a cartridge connecting structure pivotally connected thereto for connecting the cartridge to the handle connecting structure of a handle. The cartridge connecting structure has inwardly directed surfaces for mating with outwardly directed surfaces of the handle connecting structure. The cartridge connecting structure includes a latching member that is movable to release the cartridge from the handle connecting structure.

In spite of the above improvements in razor assemblies, there remains a need for improved assemblies for attaching razor handles to razor cartridges.

### SUMMARY OF THE INVENTION

In accordance with certain preferred embodiments of the present invention, a shaving assembly may include a razor cartridge having one or more cutting blades secured therein, the cartridge having an underside and a pair of resilient prongs extending from the underside. The underside of the razor cartridge preferably includes one or more cartridge bearing surfaces. In particular preferred embodiments, the underside of the razor cartridge includes a pair of cartridge bearing surfaces, each cartridge bearing surface being located on an opposition side of the resilient prongs. The cartridge bearing surfaces are preferably curved or arcuate so that the razor cartridge may be pivotally attached to a razor handle, as will be described in more detail below.

Each resilient prong extending from the underside of the razor cartridge desirably has a barb-like projection at an outer end or lower end thereof. The resilient prongs are preferably connected with the underside of the razor cartridge. In certain preferred embodiments, the resilient prongs comprise a thermoplastic material, whereby the prongs are integrally molded with the razor cartridge. The razor cartridge preferably includes a pair of opposing end walls, with the one or more cutting blades extending between the end walls. The barb-like projections of the resilient prongs preferably include a guide surface that slopes between the outer end of the resilient prong and toward one of the end walls of the cartridge. In other words, the sloping guide surface slopes upwardly and outwardly from the outer end of the resilient prong and toward one of the end walls. The sloping guide surface of the barb-like projection desirably terminates at a securing flange. The securing flange extends in a direction that is non-parallel to a longitudinal axis of the resilient prong. In preferred embodiments, the securing flange extends in a direction substantially perpendicular to the longitudinal axis of the resilient prong.

The above-described razor cartridge may be assembled with a razor handle having an upper end and a yoke secured to the upper end of the handle. The yoke desirably includes a securing seat that is adapted to capture the barb-like projections of the resilient prongs so as to attach the underside of the razor cartridge to the razor handle. The yoke also preferably includes a pair of yoke bearing surfaces provided on opposite sides of the securing seat. The yoke bearing surfaces desirably engage the cartridge bearing surfaces when the cartridge is secured to the razor handle. The yoke bearing surfaces and cartridge bearing surfaces desirably mesh with one another so that the cartridge may selectively pivot relative to the yoke.

In certain preferred embodiments, the securing seat of the yoke desirably includes a central aperture and a pair of opposing sidewalls on each side of the central aperture. Each sidewall may be sized and shaped to receive one of the barb-like projections when the resilient prongs are inserted into the central aperture of the securing seat. The distance between the sidewalls is preferably less than the distance between the outer surfaces of the barb-like projections. As a result, the sidewalls preferably engage the guide surfaces of the respective prongs so as to compress or deflect the prongs toward one another when the prongs are inserted into the central aperture. The sidewalls continue to exert a deflecting force upon the guide surfaces of the barb-like projections until the barb-like projections snap or fit into the opposing slots. Once the barb-like projections reach the opposing slots, the barb-like projections are free to slide within the slots so that the cartridge may move relative to the razor handle. In certain preferred embodiments, the elongated slots follow an arcuate path so that the razor cartridge may pivot relative to the securing seat of the yoke.

As mentioned above, the yoke desirably includes a pair of yoke bearing surfaces on opposite sides of the securing seat. The yoke bearing surfaces are desirably connected with the securing seat via support arms extending between the securing seat and the yoke bearing surfaces. The yoke bearing surfaces are preferably curved and preferably engage the cartridge bearing surfaces when the cartridge is attached to the razor handle. The yoke bearing surfaces and cartridge bearing surfaces are preferably substantially concentric so that the bearing surfaces mesh with one another for allowing sliding movement of the yoke bearing surfaces and the cartridge bearing surfaces relative to one another.

In certain preferred embodiments, the razor handle may include an ejection element connected thereto. The ejection element is desirably moveable in the central aperture of the securing seat between a retracted position and an extended position. The razor handle may include a push-button interconnected with the ejection element. The push-button may slide within a slot provided on an outer surface of the razor handle. In one particular preferred embodiment, as the push-button moves from a first end of the slot to a second end of the slot, the ejection element, interconnected with the pushbutton, moves between the retracted and extended position. As the ejection element is extended, the ejection element desirably engages with the guide surfaces of the barb-like projections for compressing or deflecting the resilient prongs toward one another, freeing the barb-like projections from being secured within the slots, and urging the resilient prongs to detach from the securing seat at an upper edge of the securing seat. Thus, the ejection element desirable engages the resilient prongs for deflecting the prongs toward one another and ejecting the prongs from the central opening of the securing seat. In particular preferred embodiments, the ejection element has a cross-section that is substantially V-shaped. The V-shaped ejection element desirably has two legs, each leg engaging one of the barb-like projections when the ejection element is in the extended position. In another preferred embodiment, the ejection element may have a substantially square or rectangular shape when view in cross-section, whereby the legs of the ejection element are substantially vertical in orientation relative to a base member of the ejection element interconnecting lower ends of the two vertical legs.

In another preferred embodiment of the present invention, a shaving assembly includes a razor cartridge having an underside and a pair of resilient prongs extending from the underside. Each of the resilient prongs desirably has a barb-like projection at an outer end, wherein the resilient prongs are deflectable in response to external forces. The shaving assembly also desirably includes a razor handle that is attachable to the razor cartridge, the razor handle including a yoke having a securing seat with opposing sidewalls and a central aperture extending between the sidewalls. Each sidewall desirably includes a slot extending therethrough. When the resilient prongs of the cartridge are inserted into the central aperture, the barb-like projections of the resilient prongs are desirably captured in the respective slots of the sidewalls so as to attach the razor cartridge to the razor handle. As the prongs are inserted into the central aperture, the sidewalls of the securing seat desirably abut against the barb-like projections for deflecting the resilient prongs toward one another. Such deflection is necessary because the distance between the sidewalls are desirably less than the distance between the outer surfaces of the barb-like projections. Thus, the barb-like projections must be deflected toward one another to slide through their relatively reduced distance between the sidewalls. The sidewalls continue to deflect the resilient prongs toward one another until the barb-like projections are inserted to a depth equivalent to the location of the slots. Upon reaching the slots, the resilient prongs are able to snap outwardly away from one another and return to their original undeflected orientation. At such time, the barb-like projections are captured within the slots of the securing seat. The barb-like projections include an upper surface that extends in a direction that is substantially non-parallel to a longitudinal axis of the prong. As a result, the securing flange maintains the barb-like projections within the slot until the resilient prongs are once again deflected for detaching the securing flange from the slot. At this time, the resilient prongs may then be dejected from the central aperture of the securing seat, thereby detaching the cartridge from the razor handle.

In certain preferred embodiments, the cartridge includes end walls and the barb-like projections include a sloping guide surface that slopes from an outer end or lower end of the resilient prongs toward one of the end walls. The sloping guide surfaces terminate at the above-described securing flange. When a razor cartridge and handle are assembled together, the securing flanges of the barb-like projections are desirably secured in the slots of the respective sidewalls of the securing seat. The securing flanges may snap-fit in the slots.

These and other preferred embodiments of the present invention will be described in more detail below.

### BRIEF DESCRIPTION OF THE DRAWINGS

FIG. 1 shows a perspective view of a razor cartridge including two resilient prongs, in accordance with certain preferred embodiments of the present invention.

FIG. 2 shows a front elevational view of the razor cartridge of FIG. 1.

FIG. 3 shows a right side view of the razor cartridge of FIG. 2.

FIG. 4 shows a perspective view of a yoke for securing the razor cartridge of FIGS. 1-3, in accordance with certain preferred embodiments of the present invention.

FIG. 5 shows a front elevational view of the yoke of FIG. 4.

FIG. 6 shows a right side view of the yoke of FIG. 5.0

FIG. 7 shows the razor cartridge of FIGS. 1-3 being aligned for attachment to the yoke of FIGS. 4-6.

FIG. 8 shows a fragmentary view of the razor cartridge of FIG. 8.

FIGS. 9A-9B show a method for assembling the razor cartridge and yoke of FIG. 7, in accordance with certain preferred embodiments of the present invention.

FIG. 10 shows a perspective view of FIG. 9B.

FIG. 11 shows a right side view of the yoke of FIG. 9B.

FIGS. 12A-12B show an assembly for detaching a razor cartridge from a yoke, in accordance with certain preferred embodiments of the present invention.

FIGS. 13A-13B show an assembly for detaching a razor cartridge from a yoke, in accordance with still further preferred embodiments of the present invention.

FIG. 14 shows a perspective view of a razor assembly including a razor handle, a flexible yoke and a razor blade cartridge, in accordance with certain preferred embodiments of the present invention.

FIG. 15 shows another perspective view of the razor assembly of FIG. 14.

### DETAILED DESCRIPTION OF PREFERRED EMBODIMENTS

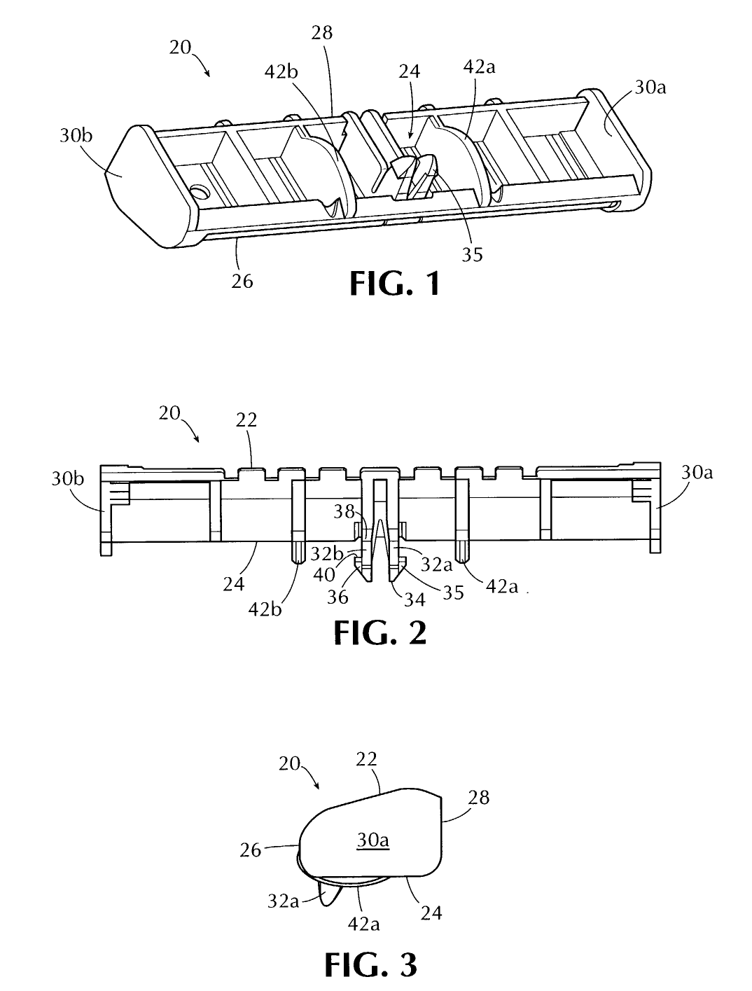

Referring to FIGS. 1-3, a razor cartridge 20 attachable to a razor handle (not shown) includes a top side 22 an underside 24, a leading edge 26 and a trailing edge 28. The razor cartridge 20 also includes opposing end walls 30A, 30B extending between leading and trailing edges 26, 28. The underside 24 of razor cartridge 20 preferably has a pair of resilient prongs 32A, 32B. The resilient prongs 32A, 32B are desirably integrally connected or molded to the underside of cartridge 20. The resilient prongs 32A, 32B are substantially similar in size and shape, and are preferably made of a resilient material, such as plastic, so that the prongs 32A, 32B may flex toward one another. The prongs are desirably made of a resilient material that returns the prongs to the substantially parallel orientation shown in FIG. 2. Each resilient prong preferably has a barb-like projection 35 at an outer end 34, the barb-like projecting having a guide surface 36 that slopes from the outer end of the resilient prong toward one of the end walls 30A, 30B of the cartridge 20. The guide surface 36 of the barb-like projection 35 desirably terminates at a securing flange 40. Each resilient prong 32A, 32B also has a flexible shaft 40 that extends between the lower end 34 of the prong and the underside 24 of the cartridge 20.

The underside 24 of razor cartridge 20 also includes a pair of cartridge bearing surfaces 42A, 42B. In preferred embodiments, the cartridge bearing surfaces are curved or arcuate for facilitating sliding pivotal movement of razor cartridge 20 relative to a seat of a razor handle, as will be described in more detail below. Referring to FIG. 3, resilient prongs 32A, 32B may extend below cartridge bearing surfaces 42A, 42B.

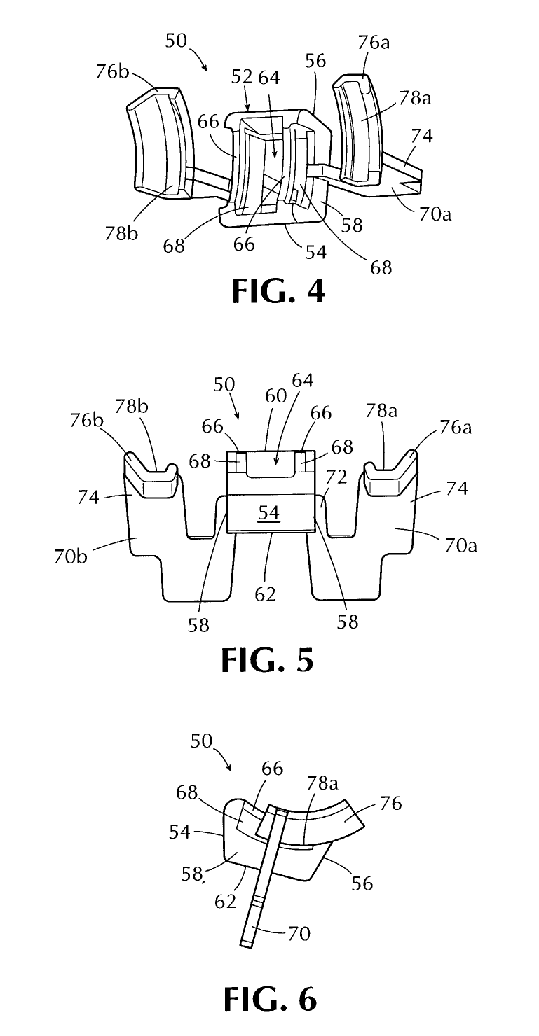

Referring to FIGS. 4-5, a yoke adapted to be pivotally connected with the razor cartridge of FIG. 1 includes a securing seat 52 having a front wall 54, a rear wall 56 and a pair of sidewalls 58 extending between the front and rear walls. Securing seat 52 also includes an upper edge 60, a lower edge 62 remote therefrom and a central aperture 64 extending from upper edge 60 to lower edge 62. In other words, the top and bottom of the securing seat is substantially open with the central aperture extending between the top and bottom. Securing seat 52 also has a pair of opposing guide bars 66 at the upper edge 60, on opposite sides of central aperture 64. The guide bars extend between the front wall 54 and rear wall 56 of securing seat 52. In certain preferred embodiments, the guide bars 66 are connected with the respective front and rear walls 54, 56 of securing seat 52. The securing seat 52 also has a pair of opposing guide slots 68 underlying the respective guide bars 66. As will be explained in more detail below, when the razor cartridge is secured to the securing seat 52, the securing flanges of the resilient prongs are preferably secured under the guard bars 66, with the outwardly extending guide surfaces 36 being extending at least partially through the opposing windows 68.

Yoke 50 also preferably includes a pair of support arms 70A, 70B having first ends 72 integrally attached to securing seat 50 and second ends 74 connected to respective yoke bearings 76A, 76B having respective bearing surfaces 78A, 78B.

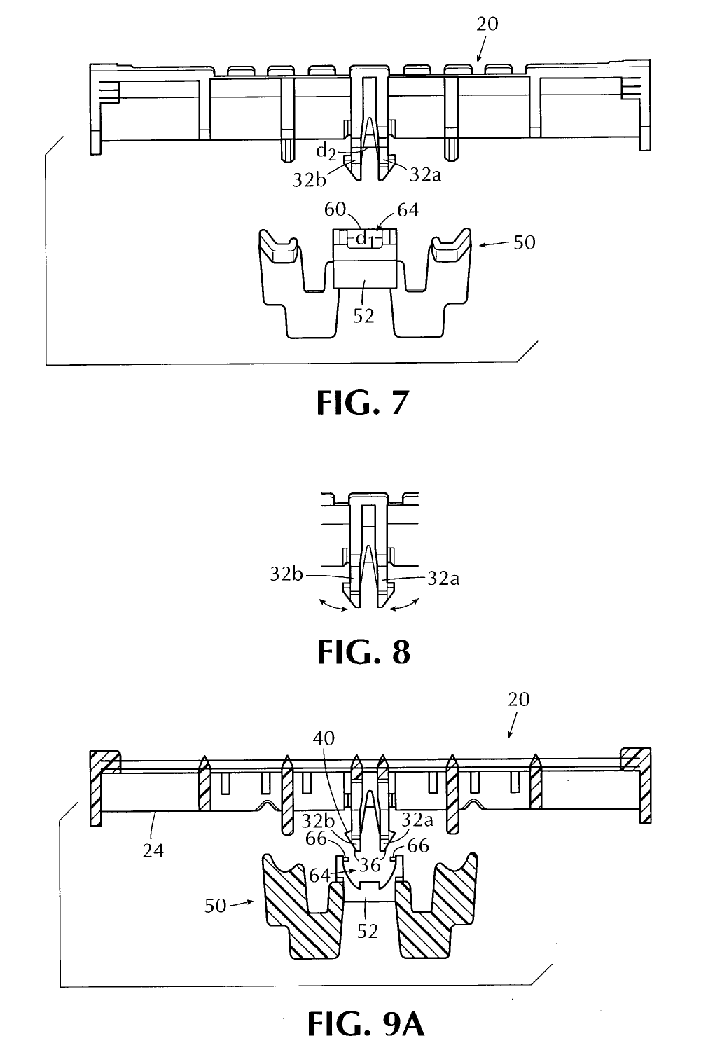

Referring to FIG. 7, razor cartridge 20 may be assembled with yoke 50 by substantially aligning the pair of resilient prongs 32A, 32B with the central opening 64 at the upper edge 60 of securing seat 52. Preferably, the distance designated D₁ is slightly greater than or substantially equal to the distance D₂. In the particular preferred embodiment shown in FIG. 7, the distance D₂ is the distance between the outer surfaces of the prong shafts 40 when the resilient prongs are undeflected.

Referring to FIG. 8, as mentioned above, the resilient prongs are compressible toward one another so as to minimize the distance therebetween. The prongs 32A, 32B are resilient so that when the compressing force is removed, the prongs return to their original undeflected orientation. The flexing movement of the prongs 32A, 32B is shown in FIG. 8 by the arrows.

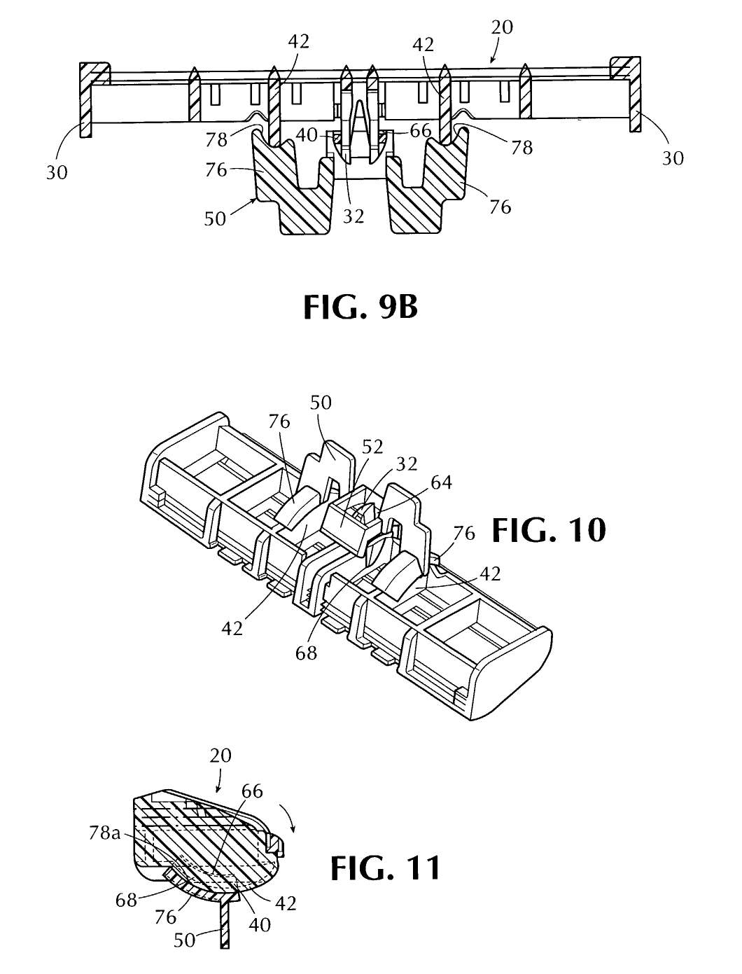

FIGS. 9A-9B show the razor cartridge 20 being pivotally attached to yoke 50, in accordance with certain preferred embodiments of the present invention. In this embodiment, the securing seat 52 of yoke 50 is preferably placed in substantial alignment with the two resilient prongs 32A, 32B. The lower ends 34 of the resilient prongs are inserted into the central aperture 64 of the securing seat 52, whereupon the outwardly extending guide surfaces 36 engage the respective guide bars 66. As the prongs 32A, 32B are further inserted, the opposing guide bars 66 compress the resilient prongs toward one another until the flange surfaces 40 pass below the undersides of the guide bars 66. Once the flange surfaces 40 have passed by guide bars 66, the resilient prongs 32A, 32B are free to flex outwardly so as to return to their original undeflected configuration, as shown in FIG. 9B.

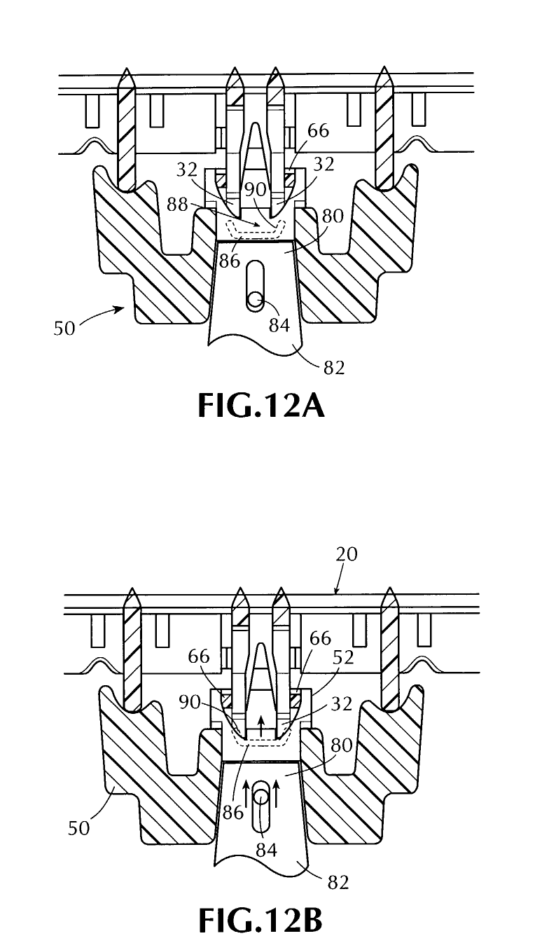

Referring to FIGS. 10 and 11, after the securing seat 52 of yoke 50 has been pivotally secured to cartridge 20, the yoke 50 and cartridge 20 are free to pivot relative to one another. As shown in FIG. 10, the yoke bearings 76 are in sliding contact with the arcuate surfaces (not shown) of the cartridge bearings 42. The outwardly sloping surfaces (not shown) of the resilient prongs 32A, 32B are slidable within the guide windows 68 on opposing sides of the central aperture 64.

Referring to FIG. 11, the yoke bearing surfaces 78 of the yoke bearings 76 engage the cartridge bearings 42, whereby the cartridge bearings 42 are free to slide within the yoke bearings 76. The resilient prongs 32A, 32B may slide between a forwardly rotated position (shown in FIG. 11) and a rearwardly rotated position (not shown). During a shaving operation, forces exerted upon the razor cartridge 20 will generally move the cartridge between the forward rotated position, the rearward rotated position, and positions therebetween.

Referring to FIGS. 12A-12B, in certain preferred embodiments the yoke 50 is attachable to an upper end 80 of a handle 82. The yoke may be permanently or releasably attached to the handle. Handle 82 includes an actuation element 84 interconnected with ejection member 86 for moving ejection member 86 between a retracted position and an extended position. Ejection member 86 includes a V-shaped channel 88 having an inner surface 90 that desirably slopes outwardly. The inner surface 90 is adapted to engage the outwardly sloping surfaces of the resilient prongs 32 for compressing the prongs toward one another, thereby ultimately releasing the securing flanges from underneath the opposing guide bars 66.

Referring to FIG. 12B, actuation element 84 is slidable toward the upper end 80 of handle 82, which in turn, forces ejection element 86 to abut against the outwardly sloping surfaces of resilient prongs 32A, 32B, respectively. As ejection element 86 is extended, the inner surface 90 of the V-shaped groove 88 compresses the resilient prongs together, and for urging the prongs to unseat from the securing seat 52 of yoke 50. As mentioned above, the resilient prongs are compressed toward one another until the respective flange portions are freed from engagement with guide bars 66. Once the flanges 40 of resilient prongs 32A, 32B are free of the guide bars 66, the resilient prongs spring back to their original configuration, whereupon the cartridge 20 is unseated from the central opening 64.

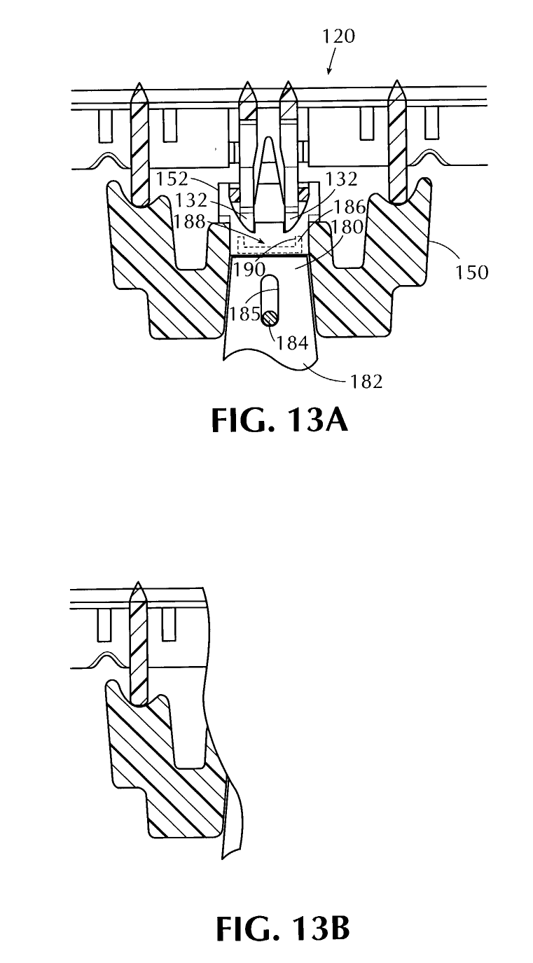

FIGS. 13A and 13B show an ejection member for selectively detaching a razor cartridge 120 from a yoke 150, in accordance with another preferred embodiment of the present invention. In this particular embodiment, razor handle 182 has upper end 180 having substantially rectangular shaped ejection element 186 projecting therefrom. Ejection element 186 is connected with actuation element 184 slidable within slot 185 of handle 182. Ejection element 186 is movable between the retracted position shown in FIG. 13A and the extended position shown in FIG. 13B. To eject cartridge 120 from its attachment to yoke 150, the actuation element 184 is slid toward the upper end 180 of razor handle 182. As a result, the ejection element 186 having notch 188 with substantially vertical sidewalls 190 engages opposing resilient prongs 32A, 32B, thereby compressing the resilient prongs toward one another. As the ejection element is extended, vertical walls 190 engage the outwardly sloping surfaces of the resilient prongs for decoupling the securing flanges 140 from engagement with the guide bars 166. Once the flange surfaces 140 are free of the guide bars 166, the ejection element asserts an upwardly-directed force for unseating the resilient prongs from engagement with the securing seat 152. At this point, a spring (not shown) preferably returns the ejection element 186 and actuation element 184 to the original retracted position shown in FIG. 13A.

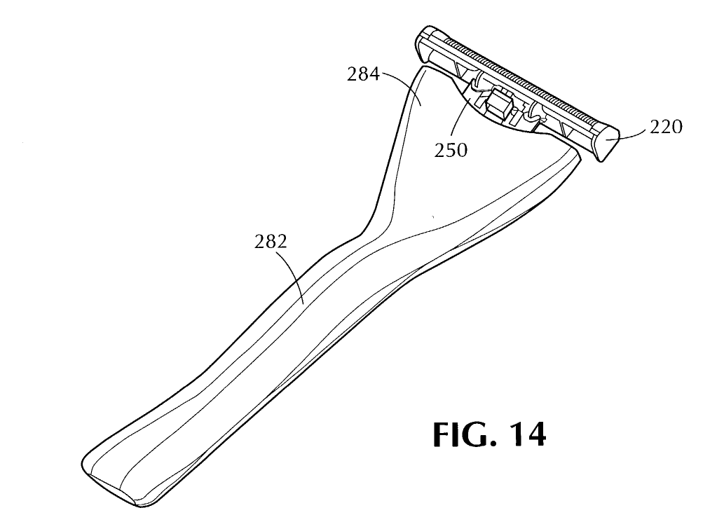

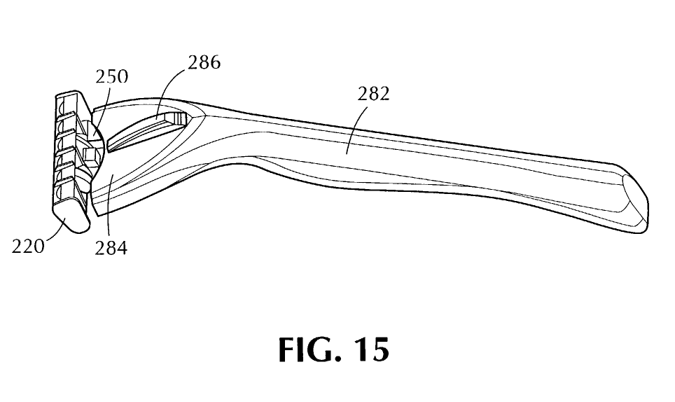

FIGS. 14 and 15 show a razor assembly including a razor handle 282 attachable to a flexible yoke 250, such as a yoke having the structure described above. Razor assembly includes razor handle 282 having upper end 284 adapted to secure yoke 250. In turn, yoke 250 is secured to an underside of razor cartridge 220. Referring to FIG. 15, razor handle 282 includes depressible or movable button 286 for detaching yoke 250 from cartridge 220, such as when it is desirable to attach a replacement razor blade cartridge 220 to razor handle 282.

Although the invention herein has been described with reference to particular embodiments, it is to be understood that these embodiments are merely illustrative of the principles and applications of the present invention. It is therefore to be understood that numerous modifications may be made to the illustrative embodiments, and that other arrangements may be devised without departing from the spirit and scope of the present invention as defined by the appended claims.

What is claimed is:

1. A shaving assembly comprising:
a razor cartridge having an underside and a pair of resilient prongs extending from the underside, each said resilient prong having a barb-like projection at an outer end, wherein said resilient prongs are deflectable in response to external forces.

2. The shaving assembly as claimed in claim 1, wherein the underside of said razor cartridge includes cartridge bearing surfaces on opposite sides of said resilient prongs.

3. The shaving assembly as claimed in claim 2, wherein said cartridge bearing surfaces are arcuate.

4. The shaving assembly as claimed in claim 2, wherein said cartridge includes end walls and wherein each said barb-like projection includes a guide surface that slopes from the outer end of said resilient prong toward one of the ends walls of said cartridge.

5. The shaving assembly as claimed in claim 4, wherein the guide surface of said barb-like projection terminates at a securing flange.

6. The shaving assembly as claimed in claim 5, wherein each said resilient prong has a longitudinal axis and wherein the securing flange extends in a non-parallel direction relative to the longitudinal axis.

7. The shaving assembly as claimed in claim 1, further comprising a razor handle having a yoke with a securing seat adapted to capture the barb-like projections of said resilient prongs for attaching said razor cartridge to said razor handle.

8. The shaving assembly as claimed in claim 7, said securing seat including a central aperture and a pair of opposing side walls on each side of said central aperture, each said side wall including a slot, wherein the barb-like projections of said resilient prongs are insertible into said central aperture for capturing the barb-like projections in the slots.

9. The shaving assembly as claimed in claim 8, wherein the distance between the barb-like projections is greater than the distance between said opposing side walls, and wherein said side walls deflect said resilient prongs toward one another when said prongs are inserted into said central aperture.

10. The shaving assembly as claimed in claim 7, wherein said yoke includes a pair of yoke bearing surfaces on opposite sides of said securing seat, said yoke bearing surfaces engaging the cartridge bearing surfaces when said cartridge is attached to said razor handle.

11. The shaving assembly as claimed in claim 10, wherein said yoke bearing surfaces and said cartridge bearing surfaces are substantially concentric.

12. The shaving assembly as claimed in claim 8, wherein the barb-like projections of said resilient prongs are deflectable toward one another for attaching and detaching said resilient prongs from said securing seat.

13. The shaving assembly as claimed in claim 12, wherein said barb-like projections are slidable in said elongated slots so that said cartridge and said yoke are pivotable relative to one another after said cartridge is attached to said securing seat.

14. The shaving assembly as claimed in claim 8, further comprising an ejection element connected with said razor handle, said ejection element being movable in said central aperture between a retracted position and an extended position, wherein said ejection element is engagable with said barb-like projections for compressing said resilient prongs and detaching the barb-like projections from the slots of said securing seat.

15. The shaving assembly as claimed in claim 14, wherein said ejection element is substantially V-shaped.

16. The shaving assembly as claimed in claim 14, wherein said ejection element has two legs that engage said barb-like projections when said ejection element is in the extended position.

17. A shaving assembly comprising:
a razor cartridge having an underside and a pair of resilient prongs extending from the underside, each said resilient prong having a barb-like projection at an outer end, wherein said resilient prongs are deflectable in response to external forces; and
a razor handle attachable to said razor cartridge, said razor handle including a yoke having a securing seat with opposing side walls and a central aperture extending between said opposing side walls, each said side wall including a slot extending therethrough, wherein said resilient prongs are insertible into said central aperture for capturing the barb-like projections in the slots of said side walls for attaching said cartridge to said razor handle.

18. The shaving assembly as claimed in claim 17, wherein said prongs are inserted into the central aperture, the side walls of the securing seat abutting against said barb-like projections for deflecting said resilient prongs.

19. The shaving assembly as claimed in claim 17, wherein the underside of said razor cartridge includes cartridge bearing surfaces and said yoke includes yoke bearing surfaces engagable with the cartridge bearing surfaces when said razor handle is attached to said cartridge.

20. The shaving assembly as claimed in claim 19, wherein said cartridge bearing surfaces and said yoke bearing surfaces are curved and are concentric with one another so that said cartridge and said razor handle may pivot relative to one another.

21. The shaving assembly as claimed in claim 17, wherein said resilient prongs deflect toward one another as said prongs are inserted into and removed from said securing seat.

22. The shaving assembly as claimed in claim 17, wherein said cartridge includes end walls and wherein each said barb-like projections include a guide surface that slopes from an outer end of said resilient prong toward one of the ends walls.

23. The shaving assembly as claimed in claim 22, wherein the sloping guide surface of said barb-like projection terminates at a securing flange, wherein said securing flange engages said slot when said prong is inserted into said central aperture.

24. The shaving assembly as claimed in claim 23, wherein each said resilient prong has a longitudinal axis and wherein the securing flange extends in a nonparallel direction relative to the longitudinal axis.
